(19) United States
(12) Patent Application Publication
(10) Pub. No.: US 2009/0023449 A1
(43) Pub. Date: Jan. 22, 2009

(54) METHOD AND SYSTEM FOR PERFORMING HANDOVER OF MULTIMODE-MULTIBAND TERMINAL BY USING MULTI TARGET CELL IN MOBILE COMMUNICATION ENVIRONMENT

(75) Inventors: Younglak Kim, Gyeonggi-do (KR); Sungho Shin, Seoul (KR); Jongtae Ihm, Gyeonggi-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: SK TELECOM CO., LTD., Seoul (KR)

(21) Appl. No.: 11/573,999

(22) PCT Filed: Aug. 18, 2005
(86) PCT No.: PCT/KR2005/002714

§ 371 Date: Feb. 20, 2007

(30) Foreign Application Priority Data
Aug. 20, 2004 (KR) 10-2004-0066099

(51) Int. Cl. H04W 36/38

(52) U.S. Cl. 455/438

(57) ABSTRACT

Disclosed are a method and a system for performing handover of a multimode-multiband terminal by using multi-target cells in a mobile communication environment. The method for performing handover of a multimode-multiband terminal using multi-target cells in a mobile communication environment, which increases a probability of handover and improves communication quality by using the multi-target cells in a mobile communication system including a CDMA-2000 system, which includes a base station transmitter and a base station controller and provides a CDMA-2000 service to a terminal requesting connection, and a WCDMA system, which includes a radio transceiver subsystem (RTS) and a radio network controller (RNC) and provides a WCDMA service to the terminal requesting the terminal, comprises the steps of: (a) receiving a WCDMA signal transmitted from the WCDMA system through a WCDMA modem and measuring an energy of carrier/interference of others (Ec/Io) value; (b) turning on a CDMA-2000 modem according to the measured value and entering into an idle state; (c) creating multi-target cell information by monitoring a target cell for handover; (d) requesting handover to the WCDMA system; (e) receiving a handover command from the WCDMA system; and (f) turning off the WCDMA modem and switches a communication link to the CDMA-2000 system through the CDMA-2000 modem.

### TECHNICAL FIELD

The present invention relates to a method and a system for performing the handover of a multimode-multiband terminal using multi-target cells in a mobile communication environment, and more particularly to a method and a system for performing handover of a multimode-multiband terminal using multi-target cells in a mobile communication environment, which increase the probability of handover by using the multi-target cells when a mobile communication system including a CDMA-2000 system and a WCDMA system performs the handover of the multimode-multiband terminal.

### BACKGROUND ART

A mobile communication service has continuously developed from the 1^{st} generation mobile communication service based on low quality voice communication provided in Advanced Mobile Phone Service (AMPS) for analog cellular commenced during the second half of 1980's. The 2^{nd} generation mobile communication service enables enhanced voice communication and a data service of a low rate (14.4 kbps) provided through digital cellular schemes, such as Global System for Mobile (GSM), Code Division Multiple Access (CDMA), and Time Division Multiple Access (TDMA). Additionally, in the 2.5^{th} generation mobile communication service, Personal Communication Service (PCS), which can be globally used while ensuring a GHz-level frequency band, is developed, so that it is possible to provide enhanced voice communication and data service having a low data rate of 144 kpbs. A mobile communication network for a mobile communication service of the 2.5^{th} generation or before the 2.5^{th} generation includes a variety of communication devices, such as a user equipment, a base station transmitter (BST), a base station controller (BSC), a mobile switching center (MSC), a home location register (HLR), and a visitor location register (VLR).

The 3^{rd} generation mobile communication services are classified into services provided through an asynchronous WCDMA system mainly suggested by the 3^{rd} Generation Partnership Project (3GPP) group and services provided through a synchronous CDMA-2000 system mainly suggested by the 3GPP2 group. Particularly, the WCDMA system is a wireless protocol recommended by the IMT-2000, and many communication service providers all over the world are providing or preparing communication services based on the WCDMA system.

The WCDMA system not only uses a spread spectrum scheme, but also ensures superior communication quality, so that the WCDMA system is suitable for mass storage data transmission. The WCDMA system employs 32 Kbps-ADPCM (Adaptive Differential Pulse Code Modulation) for voice coding and supports high mobility allowing the communication of a user even when the user is moving at a speed of about 100 Km per hour. The WCDMA communication scheme has been employed by majority of nations, and the 3GPP formed by many organizations of Korea, Europe, Japan, The United States, China, etc., continuously develops technical specifications for the WCDMA. In the mean time, even the nations such as Korea, The United States, China, etc., which basically provide a CDMA 2000 service, commence a WCDMA service through the construction of the WCDMA system due to advantages of the WCDMA system described above.

FIG. 1 is a view briefly illustrating a mobile communication system for providing the WCDMA service in the communication environment in which the CDMA-2000 system is constructed. The WCDMA service in a CDMA-2000 area 120 providing the CDMA-2000 service is provided in a portion of the CDMA-2000 area 120. In the following procedure, it is assumed that areas providing the WCDMA service in the CDMA-2000 area 120 are overlay areas 130 and 140. In other words, a mobile communication subscriber may selectively receive either the CDMA-2000 service or the WCDMA service in the overlay areas 130 and 140. Herein, in order to use both the CDMA-2000 service and the WCDMA service, a multimode-multiband terminal 110 is required.

The multimode-multiband (MM-MB) terminal 110 is a mobile communication terminal supporting both multi-modes and the multi-bands. The multimode includes a synchronous mode and an asynchronous mode, and the multiband includes a frequency band of 800 MHz for the 2^{nd} generation mobile communication service, a frequency band of 1.8 GHz for the 2.5^{th} generation mobile communication service, a frequency band of about 2 GHz for the 3^{rd} generation mobile communication service, and a frequency band for a 4^{th} generation mobile communication service to be provided in the future. The MM-MB terminal 110 operates by performing switching between a WCDMA mode and a CDMA-2000 mode according to the type of a communication service provided in an area including the MM-MB terminal 110.

If the mobile communication subscriber deviates from the overlay area 130 and moves to the CDMA-2000 area 120, the MM-MB terminal 110 performs a handover operation. The handover operation denotes an operation maintaining a communication link between the multimode-multiband terminal 110 and the mobile communication system even if a service area changes.

The multimode-multiband terminal 110 establishes a communication link with the WCDMA system in the overlay area 130. However, if the multimode-multiband terminal 110 enters the CDMA-2000 service area 120, the multimode-multiband terminal 110 switches a communication link into the CDMA-2000 system through switching between the WCDMA modem and the CDMA-2000 modem. However, in the conventional handover procedure, the multimode-multiband terminal 110 performs an initialization operation by driving the CDMA-2000 modem embedded therein and searches for a target cell of the CDMA-2000 service area 120, which will establish a communication link with the terminal 110, in an idle state. Conventionally, the CDMA-2000 modem has used only one target cell for handover in the idle state. If only one target cell for the handover is used, and if wireless environment rapidly changes due to movement of the multimode-multiband terminal, the handover may fail.

### DISCLOSURE OF THE INVENTION

Therefore, the present invention has been made in view of the above-mentioned problems, and it is an object of the present invention to provide a method and a system for performing handover of a multimode-multiband terminal using multi-target cells in a mobile communication environment, which increases the probability of handover by allowing a CDMA-2000 modem having finished an initialization operation to use multi-target cells when searching for a target cell for the handover in the procedure of receiving a mobile communication service by means of a multimode-multiband terminal.

In order to accomplish the above object, there is provided a method for performing handover of a multimode-multiband terminal using multi-target cells in a mobile communication environment, which increases a probability of handover and improves communication quality by using the multi-target cells in a mobile communication system including a CDMA-2000 system and a WCDMA system, the CDMA-2000 system including a base station transmitter and a base station controller and providing a CDMA-2000 service to a terminal requesting connection, the WCDMA system including a radio transceiver subsystem (RTS) and a radio network controller (RNC) and providing a WCDMA service to the terminal requesting the terminal, the method comprising the steps of: (a) receiving a WCDMA signal transmitted from the WCDMA system through a WCDMA modem and measuring an energy of carrier/interference of others (Ec/Io) value; (b) turning on a CDMA-2000 modem according to the measured value and entering into an idle state; (c) creating multi-target cell information by monitoring a target cell for handover; (d) requesting handover to the WCDMA system; (e) receiving a handover command from the WCDMA system; and (f) turning off the WCDMA modem and switches a communication link to the CDMA-2000 system through the CDMA-2000 modem.

According to another aspect of the present invention, there is provided a multimode-multiband terminal which increases a probability of handover and improves communication quality by using multi-target cells in a mobile communication system including a CDMA-2000 system and a WCDMA system, the CDMA-2000 system including a base station transmitter and a base station controller and providing a CDMA-2000 service to a terminal requesting connection, the WCDMA system including a radio transceiver subsystem (RTS) and a radio network controller (RNC) and providing a WCDMA service to the terminal requesting the terminal, the multimode-multiband terminal comprising: an antenna for transmitting and receiving an RF signal through an air interface; an RF transceiver for transmitting, receiving, and modulating the RF signal; a CDMA-2000 filter for extracting only a desired CDMA signal from RF signals having a CDMA-2000 band from the RF transceiver; a CDMA-2000 modem for performing call processing for the CDMA signal according to a protocol defined in a CDMA-2000 specification; a WCDMA filter for extracting only a desired WCDMA signal from RF signals having a WCDMA band from the RF transceiver; a WCDMA modem for performing call processing for the WCDMA signal according to a protocol defined in a WCDMA specification; a controller for performing a control operation so that one of a WCDMA mode and a CDMA-2000 mode is selected; and a program storage module including a real time operating system and a multi-target cell monitoring program.

According to still another aspect of the present invention, there is provided a mobile communication system for providing a CDMA-2000 service and a WCDMA service to a multimode-multiband terminal, thereby reducing time of searching for a target cell and improving a probability of handover and communication quality by using multi-target cells, the mobile communication system comprising: a CDMA-2000 radio access network for providing the CDMA-2000 service through a traffic channel among signal channels and being arranged based on a cell unit; a WCDMA radio access network for providing the WCDMA service through a traffic channel among signal channels and being arranged based on a cell unit; and a mobile switching center for processing basic and additional services, incoming and outgoing calls of a subscriber, a location information registration procedure, a handover procedure, and an interconnection function with another network and being connected with the CDMA-2000 radio access network and the WCDMA radio access network.

### BRIEF DESCRIPTION OF THE DRAWINGS

FIG. 1 is a view briefly illustrating a mobile communication system for providing a WCDMA service in a communication environment in which a CDMA-2000 system is basically constructed,

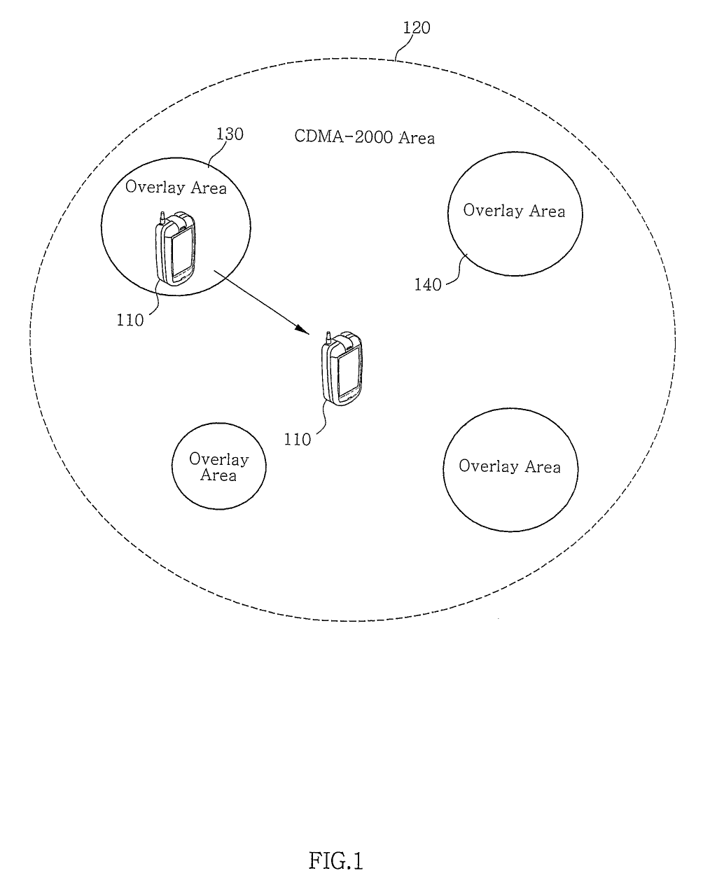

FIG. 2 is a block diagram illustrating an internal structure of a multimode-multiband terminal according to a preferred embodiment of the present invention,

FIG. 3 is a view illustrating a mobile communication system establishing a communication link with a multimode-multiband terminal according to a preferred embodiment of the present invention, and

FIG. 4 is a flowchart illustrating a handover procedure of a multimode-multiband terminal according to a preferred embodiment of the present invention.

### BEST MODE FOR CARRYING OUT THE INVENTION

Reference will now be made in detail to the preferred embodiments of the present invention.

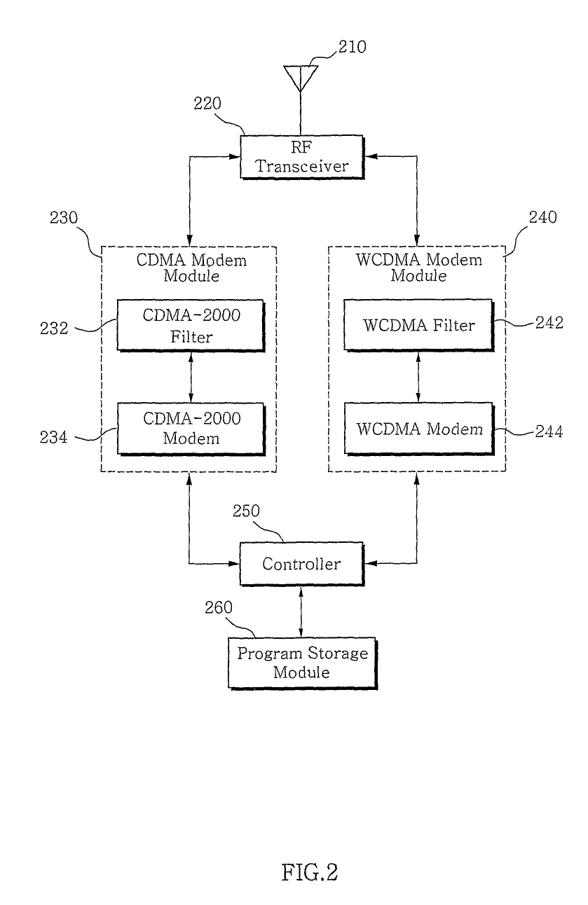

FIG. 2 is a block diagram illustrating an internal structure of a multimode-multiband terminal according to a preferred embodiment of the present invention.

A multimode-multiband terminal includes an antenna 210, an RF transceiver 220, a CDMA modem module 230, a WCDMA modem module 240, a controller 250, and a program storage module 260.

The antenna 210 receives an RF signal transmitted therein from a base station in a neighboring area and delivers the RF signal to the RF transceiver 220. In addition, the antenna 210 receives a modulated RF signal from the RF transceiver 220 so as to transmit the modulated RF signal into the air.

The RF transceiver 220 demodulates an RF signal received from the antenna 210 and then delivers the demodulated RF signal to a CDMA-2000 filter 232 of the CDMA modem module 230 or a WCDMA filter 242 of the WCDMA modem module 240. The RF transceiver 220 receives data to be transmitted from the CDMA modem module 230 or the WCDMA modem module 240, modulates the received data into an RF signal, and then sends the modulated RF signal into the air through the antenna 210.

The CDMA modem module 230 includes the CDMA-2000 filter 232 and a CDMA-2000 modem 234 for a CDMA-2000 service. The CDMA-2000 filter 232 extracts only a digital signal having a CDMA-2000 band from RF signals demodulated in the RF transceiver 220 according to an operation mode of the multimode-multiband terminal and delivers the extracted digital signal to the CDMA-2000 modem 234. In addition, the CDMA-2000 modem 234 performs call processing for the digital signal having a CDMA-2000 band delivered through the CDMA-2000 filter 232 according to a protocol defined in the CDMA-2000 specification.

The WCDMA modem module 240 includes the WCDMA filter 242 and a WCDMA modem 244 for a WCDMA service. The WCDMA filter 242 extracts only a digital signal having a WCDMA band from the RF signals demodulated in the RF transceiver 220 according to an operation mode of the multimode-multiband terminal and delivers the extracted digital signal to the WCDMA modem 244. In addition, the WCDMA modem 244 processes the digital signal having the WCDMA band delivered through the WCDMA filter 242 and performs call processing for the digital signal according to a protocol defined in the WCDMA specification.

The controller 250 controls the overall operation of the multimode-multiband terminal. In addition, the controller 250 controls the multimode-multiband terminal to operate through selection either the WCDMA mode or the CDMA-2000 mode according to a type of the received RF signal (a WCDMA signal or a CDMA-2000 signal). If a specific mode is selected, the controller 250 performs a control operation such that a corresponding specific modem among the CDMA-2000 modem 234 and the WCDMA modem 244 can operate by transmitting a control signal to the CDMA modem module 230 or the WCDMA modem module 240.

The program storage module 260 includes an EEPROM (Electrically Erasable Programmable Read-Only Memory), which can easily be read and written, a flash memory, and a PAM (a random access memory) and is mounted on a circuit substrate (not shown) embedded in the multimode-multiband terminal. The flesh memory has an OS (real time operating system) and a multi-target cell monitoring program installed therein, and these programs are loaded onto the RAM and executed. The multi-target cell monitoring program is controlled in such a manner that it searches for not one target cell for handover, but a plurality of target cells for handover existing around the multimode-multiband terminal in an idle state after an initialization operation of the CDMA-2000 modem is finished. In addition, the multi-target cell monitoring program denotes a software for calculating an Ec/Io (Energy of Carrier/Interference of Others) value using a CDMA-2000 pilot signal received through the antenna 210 and the RF transceiver 220 and requesting handover toward a base station transmitting a pilot signal having the greatest Ec/Io value among the calculated resultant values.

Herein, the Ec/Io denotes the ratio of the intensity of a pilot signal to the intensity of all received noises and a unit representing the quality of the pilot signal. Generally, the Ec/Io is a value within the range of about −1˜−2 dB in area in which there is a lower amount of communication and radio waves are not overlapped with each other, a value within the range of about −6˜−12 dB in area in which there is a great amount of communication and radio waves are overlapped with each other, and a value of about −10 dB in the upper part of a skyscraper in which radio waves are overlapped with each other. In addition, an Ec/Io value within the range of −10˜−14 dB causes call drop, and an Ec/Io value smaller than −14 dB causes a communication fault state.

In other words, according to the present invention, the controller 250 executes the multi-target cell monitoring program installed in the program storage unit 260 and controls the executed multi-target cell monitoring program to monitor a plurality of target cells for handover after the initialization operation is finished.

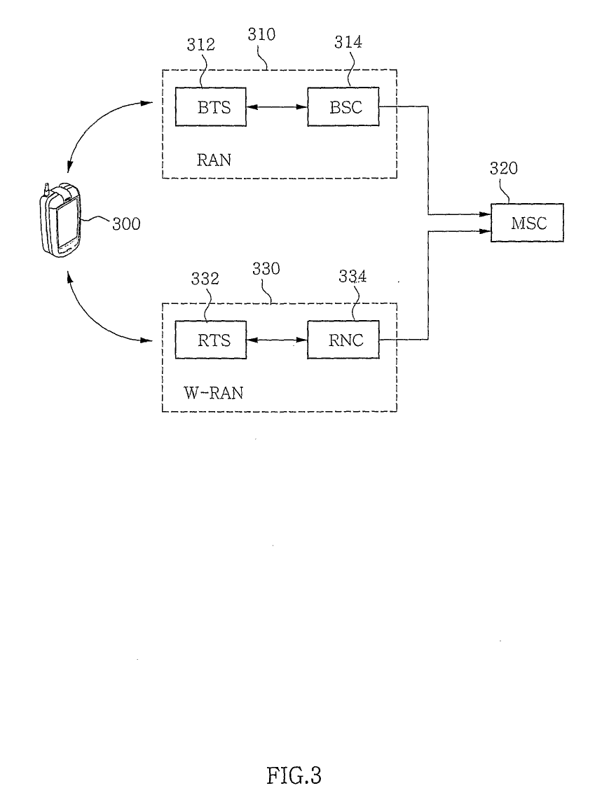

FIG. 3 is a view illustrating a mobile communication system establishing a communication link with the multimode-multiband terminal according to a preferred embodiment of the present invention.

The mobile communication system according to a preferred embodiment of the present invention includes a multimode-multiband terminal 300, a radio access network (RAN) 310, a WCDMA radio access network (W-RAN) 330, and a mobile switching center (MSC) 320.

According to the present invention, the multimode-multiband terminal 300 supports both a multimode and multi-bands and has a multi-target cell monitoring program installed therein. If the multimode-multiband terminal 300 moves to a CDMA-2000 area from an overlay area, the multimode-multiband terminal 300 turns on the CDMA-2000 modem, performs an initialization operation, and then monitors a target cell for handover in an idle state. Herein, the multimode-multiband terminal 300 monitors a plurality of target cells around the terminal 300 within a service area boundary.

The RAN 310, which is a component of the mobile communication system supporting a CDMA-200 service, includes a base station transmitter (BST) 312 and a base station controller (BSC) 314 and is connected with the MSC 320.

The BST 312, which is arranged based on a cell, receives a call request signal from the multimode-multiband terminal 300 through a traffic channel among signal channels and transmits the received call request signal to the BSC 314. In addition, the BST 312 registers location information used for detecting the position of the multimode-multiband terminal 300 existing in a cell managed by the BST 312. In addition, the BST 312 is a network end-point device directly connected with the multimode-multiband terminal 300 by performing base band signal processing, wire/wireless conversion, transmission/reception of a radio signal.

The BSC 314 controls the BST 312 and performs radio channel assignment and release for the multimode-multiband terminal 300, control of transmit power of the multimode-multiband terminal 300 and the BST 312, determination of soft handover and hard handover between cells, transcoding and vocoding, GPS clock distribution, and operation and maintenance for a base station.

In addition, the BSC 314 transmits subscriber information of the multimode-multiband terminal 300, the position of which is registered, to the MSC 320. The BSC 314 delivers a call request signal transmitted from the multimode-multiband terminal 300 through the BST 312 to the MSC 320. In contrast, the BSC 314 delivers a call request signal delivered from the MSC 320 to the multimode-multiband terminal 300 through the BSC 312.

The MSC 320 processes basic and additional services, incoming and outgoing calls of a subscriber, a location information registration procedure, a handover procedure, and interconnection functions with other networks. The MSC 320 of the IS-95/A/B/C system includes an access switching subsystem (ASS) for processing distributed calls, an interconnection network subsystem (INS) for processing a centralized call, a central control subsystem (CCS) for performing centralized functions such as operation and maintenance functions, and a location registration subsystem (LRS) for storing and managing information about a mobile subscriber.

In addition, the MSC 320 for the 3^{rd} and 4^{th} generation communication includes an asynchronous transfer mode (ATM) switch (not shown), which enhances the data transmission rate and line use efficiency by using cell-based packet transmission.

The W-RAN 330 is a mobile communication system supporting a WCDMA service and includes a radio transceiver subsystem (RTS) 332 and a radio network controller (RNC) 334. In addition, the W-RAN 330 is connected with the MSC 320.

The RTS 332 includes a base station interconnection subsystem (BIS), a base band subsystem (BBS), and a radio frequency subsystem (RFS). The RTS 332 performs a radio access end-point function with a terminal according to a 3GPP air interface specification, transmits/receives voice data and video data through a WCDMA scheme, and transmits/receives information to/from a terminal through a transmit/receive antenna.

The radio network controller (RNC) 334 performs functions of managing a base station and a radio network controller, such as a wire/wireless channel management function (a resource management function), a terminal protocol interface function, a base station protocol interface function, a control path processing function, a soft handover processing function, a core network protocol processing function, a general packet radio service (GPRS) and lur connection function, a system loading function, and a fault management function.

Hereinafter, the overall operation according to the present invention will be described. It is assumed that the multimode-multiband terminal 300 initially establishes a communication link in the W-RAN 330 for providing a WCDMA service. If the mobile communication subscriber operates the multimode-multiband terminal 300, the multimode-multiband terminal 300 automatically enters into a receive state so as to sequentially search for 21 set-up channels specified as signal channels among 333 channels (in an administration bandwidth of 10 MHz). At this time, the multimode-multiband terminal 300 selects a set-up channel having relatively greater radio wave intensity among the 21 set-up channels so as to synchronize with the frequency of the set-up channel. In other words, since different set-up channels are allocated to all neighboring base stations, the synchronization with the frequency of the set-up channel having relatively greater radio wave intensity means that the multimode-multiband terminal 300 selects a base station closest to the multimode-multiband terminal 300 as a base station for setting-up a communication link.

This indicates that, although it is not a communication state, the multimode-multiband terminal 300 can always respond to a call of the base station and that the multimode-multiband terminal 300 is ready to immediately transmit a signal when the subscriber intends to make communication. In addition, this means that the mult-imode-multiband terminal 300 is automatically ready to make communication regardless of the intention of the subscriber.

Thereafter, if the mobile communication subscriber moves to the radio access network 310 providing a CDMA-2000 service, the multimode-multiband terminal 300 performs a handover operation of switching a communication link established in the WCDMA system into the CDMA-2000 system through a switching operation between the WCDMA modem and the CDMA 2000 modem. At this time, the multimode-multiband terminal 300 monitors target cells for the handover operation in an idle state. In this case, although only a target cell is used in the conventional technique, the operation of the multimode-multiband terminal 300 is controlled according to the present invention in such a manner that a plurality of neighboring target cells are used through the multi-target cell monitoring program.

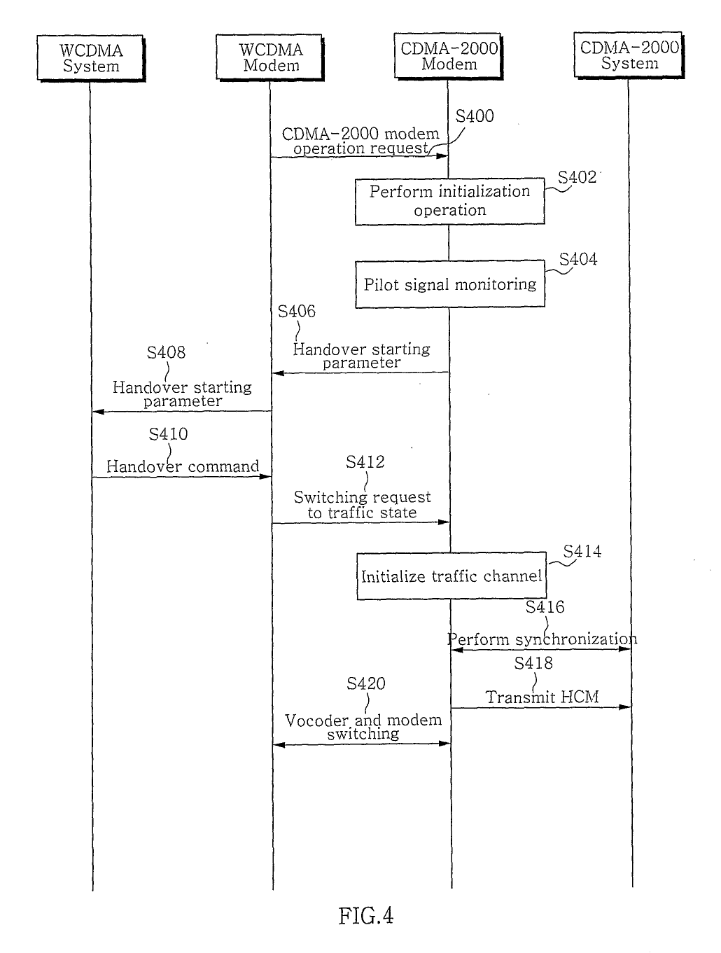

FIG. 4 is a flowchart illustrating a handover procedure of the multimode-multiband terminal 300 according to a preferred embodiment of the present invention.

In the following procedure, it is assumed that the multimode-multiband terminal 300 establishes a communication link in an overlay area 110 and moves to a CDMA-2000 area 120.

If the multimode-multiband terminal 300 moves to the CDMA-2000 area 120 from the overlay area 110, the switch between a WCDMA mode and a CDMA-2000 mode is required. In other words, if the multimode-multiband terminal 300 having received the WCDMA service in the overlay area 110 moves to the CDMA-2000 area 120, the WCDMA mode is switched into the CDMA-2000 mode.

The controller 250 of the multimode-multiband terminal 300 creates an ‘ON parameter’ for operating the CDMA-2000 modem 234 and delivers the parameter to the CDMA-2000 modem 234. The CDMA-2000 modem 234 having received the ‘On parameter’ performs an initialization operation (step S402). Herein, the initialization operation denotes an operation of setting information required for the operation of the multimode-multiband terminal 300 and then making an environment for transition into an idle state. The initialization operation includes a sequence of a system determination sub-state, a pilot channel acquisition sub-state, and a sync channel acquisition sub-state. The CDMA-2000 modem 234 having finished the initialization operation monitors pilot signals transmitted therein from a plurality of base stations positioned at the CDMA-2000 area 120 and detects base stations having great radio wave intensity (step S404). Herein, the multimode-multiband terminal 400 according to the present invention monitors neighboring target cells through the multi-target cell monitoring program. The multimode-multiband terminal 400 determines a plurality of target cells for handover according to the monitoring result, creates a handover starting parameter including information about the target cells, and then transmits the parameter to the WCDMA modem 244 (step S406).

The WCDMA modem 244 having received the handover starting parameter determines if it performs hand over and delivers the handover starting parameter including information about the target cells to the WCDMA system, thereby requesting hand over (step S408).

The WCDMA system having received the handover starting parameter including information about the target cells from the multimode-multiband terminal 300 creates a handover command including information about the target cells and transmits the handover command to the multimode-multiband terminal 300 (step S410), and the multimode-multiband terminal 300 controls the CDMA-2000 modem 234 to switch the idle state into a traffic state (step S412). Herein, since information about a plurality of target cells for hand over is transmitted between the WCDMA system and the multimode-multiband terminal 300, the multimode-multiband terminal 300 performs a handover operation using the target cells. Accordingly, since the multimode-multiband terminal 300 can selectively use the target cells when idle handover is performed in the idle state, or when the intensity of a cell signal of a target cell is degraded, it is possible to reduce the failure of hand over.

The CDMA-2000 modem 234 initializes a traffic channel in order to switch into the traffic state (step S414) and synchronizes with a target base station for the establishment of a communication link through an up link (step S416). The CDMA-2000 modem 234 having completely synchronized with the corresponding base station in step S416 creates a handover completion message (HCM) indicating that the handover is completed and transmits the HCM to the base station (step S418). The multimode-multiband terminal 400 having completely synchronized with the CDMA-2000 system turns off the operation of the WCDMA modem 244 and interconnects a vocoder with the CDMA-2000 modem 234, thereby commencing communication through the CDMA-2000 modem 234 (step S420)

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

### INDUSTRIAL APPLICABILITY

As described above, according to the present invention, a multimode-multiband terminal attempting handover selectively uses a plurality of target cells when handover is performed in an idle state, or when the intensity of a cell signal of a target cell is degraded, so that it is possible to increase a the probability of the handover and improve communication quality.

1. A method for performing handover of a multimode-multiband terminal using multi-target cells in a mobile communication environment, which increases a probability of handover and improves communication quality by using the multi-target cells in a mobile communication system including a CDMA-2000 system and a WCDMA system, the CDMA-2000 system including a base station transmitter and a base station controller and providing a CDMA-2000 service to a terminal requesting connection, the WCDMA system including a radio transceiver subsystem (RTS) and a radio network controller (RNC) and providing a WCDMA service to the terminal requesting the terminal, the method comprising the steps of:
(a) receiving a WCDMA signal transmitted from the WCDMA system through a WCDMA modem and measuring an energy of carrier/interference of others (Ec/Io) value;
(b) turning on a CDMA-2000 modem according to the measured value and entering into an idle state;
(c) creating multi-target cell information by monitoring a target cell for handover;
(d) requesting handover to the WCDMA system;
(e) receiving a handover command from the WCDMA system; and
(f) turning off the WCDMA modem and switches a communication link to the CDMA-2000 system through the CDMA-2000 modem.

2. The method as claimed in claim 1, wherein the multimode-multiband terminal has a multi-target cell monitoring program installed in the multimode-multiband terminal and performs a switching operation for the communication link between the WCDMA modem and the CDMA-2000 modem when the multimode-multiband terminal is moving between service areas.

3. The method as claimed in claim 1, wherein the multi-target cell monitoring program checks the energy of carrier/interference of others (Ec/Io) value, determines handover according to the checked value, monitors a plurality of target cells for handover to the CDMA-2000 system or the WCDMA system, and creates the multi-target cell information.

4. The method as claimed in claim 1, wherein, in step (c), the multimode-multiband terminal receives the WCDMA signal by periodically searching for a common pilot channel (CPICH) of the WCDMA system.

5. The method as claimed in claim 1, wherein, in step (a), the WCDMA modem measures the energy of carrier/interference of others (Ec/Io) value and creates an ‘ON parameter’ requesting operation of the CDMA-2000 modem according to the measurement result.

6. The method as claimed in claim 5, wherein the operation of the CDMA-2000 modem is requested when the measurement result represents that Ec/Io value is constantly maintained during a predetermined time interval sufficient for turning on the CDMA-2000 modem.

7. The method as claimed in claim 1, wherein step (b) comprises the steps of:
(b1) receiving an ‘ON parameter’ from the WCDMA modem;
(b2) performing an initialization operation of the CDMA-2000 modem; and
(b3) detecting a base station of a cell transmitting a CDMA signal having great radio wave intensity by monitoring a CDMA signal transmitted from the CDMA-2000 system after the initialization operation.

8. The method as claimed in claim 7, wherein, in step (b), the initialization operation is performed through a system determination sub-state, a pilot channel acquisition sub-state, and a sync channel acquisition sub-state.

9. The method as claimed in claim 1, wherein, in step (c), a handover starting parameter is created by inserting the multi-target cell information into the handover starting parameter and then transmitted to the WCDMA system.

10. The method as claimed in claim 1, wherein, in step (d), a handover completion message notifying that handover is completed is created after synchronization with the CDMA-2000 system and transmitted to the CDMA-2000 system.

11. The method as claimed in claim 1, wherein, in step (d), the multimode-multiband terminal maintains a communication link by switching a vocoder mounted on the multimode-multiband terminal to the CDMA-2000 modem.

12. A multimode-multiband terminal which increases a probability of handover and improves communication quality by using multi-target cells in a mobile communication system including a CDMA-2000 system and a WCDMA system, the CDMA-2000 system including a base station transmitter and a base station controller and providing a CDMA-2000 service to a terminal requesting connection, the WCDMA system including a radio transceiver subsystem (RTS) and a radio network controller (RNC) and providing a WCDMA service to the terminal requesting the terminal, the multimode-multiband terminal comprising:
an antenna for transmitting and receiving an RF signal through an air interface;
an RF transceiver for transmitting, receiving, and modulating the RF signal;
a CDMA-2000 filter for extracting only a desired CDMA signal from RF signals having a CDMA-2000 band from the RF transceiver;
a CDMA-2000 modem for performing call processing for the CDMA signal according to a protocol defined in a CDMA-2000 specification; a WCDMA filter for extracting only a desired WCDMA signal from RF signals having a WCDMA band from the RF transceiver;
a WCDMA modem for performing call processing for the WCDMA signal according to a protocol defined in a WCDMA specification;
a controller for performing a control operation so that one of a WCDMA mode and a CDMA-2000 mode is selected; and
a program storage module including a real time operating system and a multi-target cell monitoring program.

13. The multimode-multiband terminal as claimed in claim 12, wherein the controller turns off the WCDMA modem during operation of the CDMA-2000 modem and turns off the CDMA-2000 modem during operation of the WCDMA modem.

14. The multimode-multiband terminal as claimed in claim 12, wherein the multi-cell monitoring program checks an energy of carrier/interference of others (Ec/Io) value by receiving a pilot signal transmitted in the WCDMA system and creates multi-target cell information by searching for a plurality of target cells while performing handover by operating the CDMA-2000 modem based on the checked result.

15. The multimode-multiband terminal as claimed in claim 12, wherein the multi-target cell monitoring program creates a handover starting parameter including multi-target cell information so as to transmit the handover starting parameter to the CDMA-2000 system or the WCDMA system after an initialization operation of the CDMA-2000 modem.

16. The multimode-multiband terminal as claimed in claim 12, wherein the CDMA-2000 modem performs an initialization operation in a case of handover to the CDMA-2000 system, and the initialization operation is performed through a system determination sub-state, a pilot channel acquisition sub-state, and a sync channel acquisition sub-state.

17. A mobile communication system for providing a CDMA-2000 service and a WCDMA service to a multimode-multiband terminal, thereby reducing time of searching for a target cell and improving a probability of handover and communication quality by using multi-target cells, the mobile communication system comprising:
a CDMA-2000 radio access network for providing the CDMA-2000 service through a traffic channel among signal channels and being arranged based on a cell unit;
a WCDMA radio access network for providing the WCDMA service through a traffic channel among signal channels and being arranged based on a cell unit; and
a mobile switching center for processing basic and additional services, incoming and outgoing calls of a subscriber, a location information registration procedure, a handover procedure, and an interconnection function with another network and being connected with the CDMA-2000 radio access network and the WCDMA radio access network.

18. The mobile communication system as claimed in claim 17, wherein the multimode-multiband terminal comprises:
an antenna for transmitting and receiving an RF signal through an air interface;
an RF transceiver for transmitting, receiving, and modulating the RF signal;
a CDMA-2000 filter for extracting only a desired CDMA signal from RF signals having a CDMA-2000 band from the RF transceiver;
a CDMA-2000 modem for performing call processing for the CDMA signal according to a protocol defined in a CDMA-2000 specification;
a WCDMA filter for extracting only a desired WCDMA signal from RF signals having a WCDMA band from the RF transceiver;
a WCDMA modem for performing call processing for the WCDMA signal according to a protocol defined in a WCDMA specification;
a controller for performing a control operation so that one of a WCDMA mode and a CDMA-2000 mode is selected; and
a program storage module including a real time operating system and a multi-target cell monitoring program.

19. The mobile communication system as claimed in claim 17, wherein the multimode-multiband terminal performs an initialization operation for the CDMA-2000 radio access network if the multimode-multiband terminal detects that the WCDMA signal transmitted from the WCDMA radio access network becomes weakened.

20. The mobile communication system as claimed in claim 19, wherein the initialization operation is performed through a system determination sub-state, a pilot channel acquisition sub-state, and a sync channel acquisition sub-state.

21. The mobile communication system as claimed in claim 17, wherein the multimode-multiband terminal executes the multi-target cell monitoring program and creates multi-target cell information by monitoring a plurality of target cells for handover.

22. The mobile communication system as claimed in claim 17, wherein the multi-target cell monitoring program checks an energy of carrier/interference of others (Ec/Io) value by receiving a pilot signal from the WCDMA radio access network, creates multi-target cell information and transmits the multi-target cell information to the WCDMA system while performing handover by operating the CDMA-2000 modem based on the checked result.

23. The mobile communication system as claimed in claim 17, wherein the multimode-multiband terminal creates a handover completion message notifying that handover is completed and transmits the handover completion message to the CDMA-2000 radio access network after synchronization with the CDMA-2000 radio access network.

24. The method as claimed in claim 2, wherein the multi-target cell monitoring program checks the energy of carrier/interference of others (Ec/Io) value, determines handover
